(19) United States
(12) Patent Application Publication
(10) Pub. No.: US 2026/0285507 A1
(43) Pub. Date: Sep. 24, 2026

(54) Formation Flight for Imaging Resident Space Objects

(71) Applicant: The Charles Stark Draper Laboratory, Inc., Cambridge, MA (US)

(72) Inventor: Matthew R. Stoeckle, Cambridge, MA (US)

(21) Appl. No.: 19/573,072

(22) Filed: Mar. 20, 2026

Related U.S. Application Data
(60) Provisional application No. 63/775,391, filed on Mar. 21, 2025.
(60) Provisional application No. 63/790,900, filed on Apr. 18, 2025.

(51) Int. Cl. B64G 3/00; B64G 1/10; B64G 1/24; B64G 1/68; G06T 7/00; G06T 7/70

(52) U.S. Cl. CPC B64G 3/00; B64G 1/1085; B64G 1/242; B64G 1/245; B64G 1/68; G06T 7/0002; G06T 7/70; G06T 2207/10032; G06T 2207/10116; G06T 2207/30168

(57) ABSTRACT

A system for controlling a formation of space vehicles to image an object includes an input for receiving image data acquired by one or more of the space vehicles in the formation, a state estimation module for forming state estimate data for the formation of space vehicles, the state estimate data being based at least in part on relative positions and orientations of the space vehicles in the formation, and a guidance module for determining one or more guidance commands for the space vehicles in the formation based at least in part on the state estimate data, the one or more guidance commands being determined to orient the space vehicles relative to the object for imaging of the object. The one or more guidance commands may be determined to maximize an image quality of the image data while satisfying one or more vehicle constraints associated with the space vehicles.

### CROSS-REFERENCES TO RELATED APPLICATIONS

This application claims the benefit of U.S. Provisional Application No. 63/775,391 filed Mar. 21, 2025 and also claims the benefit of U.S. Provisional Application No. 63/790,900 filed Apr. 18, 2025. The entire contents of both provisional applications are hereby incorporated herein by reference

### BACKGROUND OF THE INVENTION

Formation flight involves several satellites working together to maintain a desired relative orbit. In the context of satellites (or other space vehicles), formation flying involves positioning and maneuvering multiple satellites in coordinated relative positions to achieve mission objectives, such as Earth observation, telecommunications, and space science. Sophisticated formation control algorithms are used to manage relative motion between satellites while accounting for uncertainties in satellite position, velocity, and orientation.

Some formation control algorithms also address mission-specific needs such as collision avoidance, sensor alignment, and inter-satellite communication. For scientific missions, the precise relative orientation of the satellites is important, while telecommunications require stable positions for reliable communication.

### SUMMARY OF THE INVENTION

Some formation control algorithms (sometimes referred to as “relative positioning and orientation algorithms”) are designed to optimize for precise positioning of the formation while accounting for fuel consumption due to thruster use. Aspects described herein relate to a formation control algorithm for use in imaging missions, where the algorithm controls the formation of satellites to maximize image quality (e.g., dwell time, number of pixels of a target object present, image clarity, a change over time in image clarity) while balancing against vehicle constraints such as propellant usage and navigation performance. The success of a formation flight is dependent on the quality of the resulting imaging (i.e., the formation control algorithm is “mission aware”).

In a general aspect, a method for controlling a formation of space vehicles to image an object includes receiving image data acquired by one or more of the space vehicles in the formation. The method further includes forming state estimate data for the formation of space vehicles, the state estimate data being based at least in part on relative positions and orientations of the space vehicles in the formation. The method further includes determining one or more guidance commands for the space vehicles in the formation based at least in part on the state estimate data, the one or more guidance commands being determined to orient the space vehicles relative to the object for imaging of the object.

Aspects may include one or more of the following features.

The one or more guidance commands may be determined to maximize an image quality of the image data while satisfying one or more vehicle constraints associated with the space vehicles.

The method may further include receiving one or more imaging parameters associated with the formation of space vehicles, wherein determining the one or more guidance commands for the space vehicles in the formation is further based on the one or more imaging parameters. The image data may be X-ray image data. A first space vehicle in the formation may transmit X-ray radiation and a second space vehicle in the formation may receive at least some of the transmitted X-ray radiation. The one or more imaging parameters may include a power of the transmitted X-ray radiation. The object being imaged may be located between the first space vehicle and the second space vehicle. The object may be a satellite, or the object may be part of the formation. The state estimate data may be further based at least in part on the relative position and orientation of the object.

The image data may be visible light image data. The one or more guidance commands may include one or more of a desired change in velocity command and a desired pointing command.

Determining the one or more guidance commands may include using an optimization technique. The state estimate data may be further based at least in part on a quality of the image data.

Determining the one or more guidance commands may include computing an image quality cost based at least in part on the image data, comparing the image quality cost to a threshold, and determining a corrective guidance command only when the image quality cost exceeds the threshold.

Determining the one or more guidance commands may include minimizing a cost function that includes a weighted sum of an image quality term representing a degradation in image quality of the image data and a propellant expenditure term representing a propellant cost of adjusting the formation, wherein the weighted sum is based on a first weight applied to the image quality term and a second weight applied to the propellant expenditure term.

In another general aspect, a system for controlling a formation of space vehicles to image an object includes an input for receiving image data acquired by one or more of the space vehicles in the formation, a state estimation module for forming state estimate data for the formation of space vehicles, the state estimate data being based at least in part on relative positions and orientations of the space vehicles in the formation, and a guidance module for determining one or more guidance commands for the space vehicles in the formation based at least in part on the state estimate data, the one or more guidance commands being determined to orient the space vehicles relative to the object for imaging of the object. The one or more guidance commands may be determined to maximize an image quality of the image data while satisfying one or more vehicle constraints associated with the space vehicles.

In another general aspect, software stored on a non-transitory computer-readable medium includes instructions for causing a computing system to control a formation of space vehicles to image an object. The instructions cause the computing system to receive image data acquired by one or more of the space vehicles in the formation, form state estimate data for the formation of space vehicles, the state estimate data being based at least in part on relative positions and orientations of the space vehicles in the formation, and determine one or more guidance commands for the space vehicles in the formation based at least in part on the state estimate data, the one or more guidance commands being determined to orient the space vehicles relative to the object for imaging of the object. The one or more guidance commands may be determined to maximize an image quality of the image data while satisfying one or more vehicle constraints associated with the space vehicles.

Aspects may have one or more of the following advantages.

Some aspects advantageously use image quality data as a direct input to the formation control algorithm. Conventional formation flight algorithms optimize for geometric precision of the formation itself, without regard to the quality of the output produced by the mission. By incorporating actual image quality metrics into the optimization process, the formation control algorithm can tolerate some geometric deviation when the image remains acceptable, avoiding unnecessary propellant expenditure.

Some aspects advantageously reduce propellant consumption by triggering formation corrections only when image quality has degraded below an acceptable threshold. Conventional algorithms apply corrections based on positional error bounds alone, which may cause maneuvering even when the image remains within mission requirements. The present approach allows the formation to drift within acceptable imaging bounds, reserving propellant for corrections that are actually needed to achieve mission objectives.

Some aspects advantageously enable formation flight requirements to be derived directly from desired image quality objectives. Rather than specifying position and pointing tolerances independently and then estimating their effect on image quality, the assessment tool described herein allows mission planners to specify image quality goals and compute the required navigation and control performance, simplifying mission design and vehicle selection.

Some aspects advantageously accommodate uncooperative targets. Because the guidance algorithm is mission-aware and continuously evaluates image quality based on the current relative state, it can adapt its commands as the target moves or maneuvers, maintaining imaging performance without requiring cooperation or prior knowledge of the target's behavior.

Some aspects advantageously decouple the formation control algorithm from specific vehicle designs. By operating on relative state estimates and imaging parameters as inputs and producing generalized Delta-V and pointing commands as outputs, the algorithm can be applied across a range of spacecraft configurations without modification.

Some aspects advantageously extend to imaging modalities beyond X-ray, including visible light and thermal imaging. The optimization framework is agnostic to the specific type of imaging sensor, provided that image quality metrics appropriate to the sensor are incorporated into the cost function.

Aspects described herein are directed to improvements in the technical field of spacecraft guidance, navigation, and control. The formation control algorithm described herein is not directed to an abstract idea. Rather, it is directed to a specific technical improvement in how formation flight guidance systems operate. Conventional formation flight algorithms control satellite formations based on geometric position and orientation targets that are defined independently of mission outcomes. The formation control algorithm described herein improves upon conventional algorithms by incorporating image quality data as a direct input to the guidance computation, enabling the algorithm to make formation correction decisions based on actual mission performance rather than position error alone. This results in a concrete technical improvement: reduced propellant consumption without sacrificing imaging performance, achieved through a specific algorithmic structure that couples the imaging system output to the formation guidance computation.

Similarly, the assessment tool described herein is directed to a specific technical improvement in spacecraft mission design and analysis. The tool provides a technical capability that did not previously exist, in that it provides the ability to translate formation flight performance parameters, including their statistical uncertainties, into image quality metrics, and conversely to derive formation flight performance requirements from desired image quality objectives. This bidirectional mapping between formation flight performance and imaging performance is not a mathematical concept applied in the abstract, but a specific technical tool that operates on concrete physical parameters of a spacecraft formation and imaging system to produce actionable engineering results.

The claims are directed to specific implementations of these technical improvements and not to mathematical formulas, mental processes, or abstract concepts in isolation. Any mathematical relationships recited in the claims are integrated into a practical application of controlling a formation of physical space vehicles to improve the quality of images captured during a space mission while managing the consumption of a finite propellant resource.

Other features and advantages of the invention are apparent from the following description, and from the claims.

### BRIEF DESCRIPTION OF THE DRAWINGS

FIG. 1 is a formation of satellites capturing images of an object.

FIG. 2 is a formation control module.

FIG. 3 shows different alignments of the emitter, detector, and target.

FIG. 4 is an X-ray imaging configuration.

FIG. 5 is another view of different alignments of the emitter, detector, and target.

FIG. 6 is a summary of imaging resolution factors.

FIG. 7 is a table of penetration depths for different materials.

### DETAILED DESCRIPTION

### 1 Image Aware Formation Flight

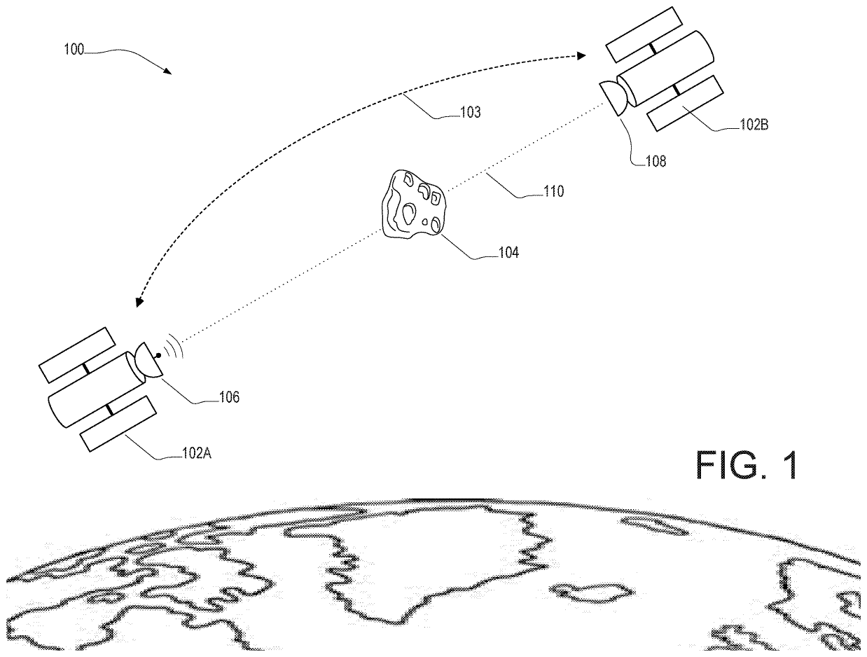

Referring to FIG. 1, a formation of satellites 100 includes two satellites 102A, 102B configured to capture images of an object 104 (e.g., an asteroid, space vehicle, or other resident space object). The formation of satellites 100 captures images of the object 104 by emitting X-rays from an X-ray emitter 106 on the first satellite 102A and sensing the X-rays after they have passed through the object 104 using an X-ray sensor 108 on the second satellite 102B. To successfully image the object 104, the formation of satellites 100 is configured such that the emitter 106 and the sensor 108 point at each other along a line 110 that passes through the object 104. A detailed description of the X-ray imaging system is provided below in Section 3, titled “X-Ray Imaging System”.

Over time, the relative positions and orientations of the satellites 102A, 102B and the object 104 tend to drift, causing misalignment of the emitter, 106, sensor 108, and object 104. Such a misalignment causes degradation of the captured image of the object 104. As is described in greater detail below, in some embodiments, a formation control module implements a formation control algorithm that is configured to use the quality of the captured (or acquired) image in an optimization procedure to control the formation in a way that maximizes the image quality while accounting for propellant usage. In other embodiments, sensor data is used to ensure the formation is tracking the object in a way that ensures high resolution imagery.

Commands generated by the formation control module are communicated among the satellites 102A, 102B over a communication link 103 (e.g., a radio frequency communication link). In some examples, the communication link 103 carries guidance commands from the formation control module 212 on the second satellite 102B to the first satellite 102A, allowing both vehicles to execute coordinated maneuvers without independent onboard guidance computation on the first satellite. In other examples, both satellites execute independent formation control algorithms and exchange state information, such as relative position estimates and imaging parameters, over the communication link 103 to remain coordinated. In some examples, the formation control algorithm is designed to be robust to temporary communication dropouts, for example by using the most recently transmitted guidance commands or by defaulting to a safe hold mode until communication is restored.

### 2 Formation Control Module

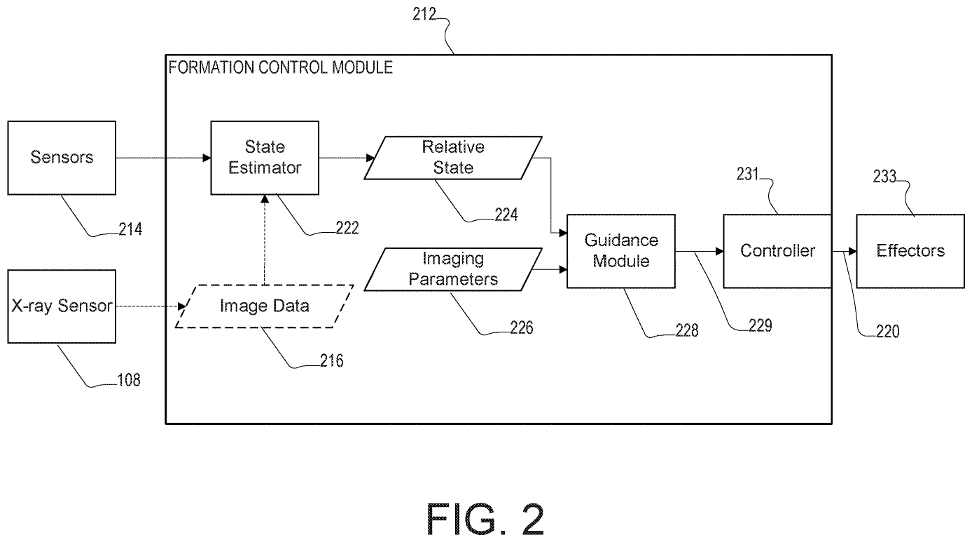

Referring to FIG. 2, in one example, the formation control module 212 is implemented on the second satellite 102B and processes data from one or more sensors 214 and, in some examples, image data 216 from the X-ray sensor 108 to determine Delta-V (i.e., a change in vehicle velocity) and attitude commands that can be used to actuate effectors 220 (e.g., thrusters) of one or both of the satellites to affect a desired change in the states of the vehicles and the formation. In some examples, the formation control module 212 includes a state estimator module 222, a guidance module 228, and a controller 231. It is noted that the state estimator module 222 and the controller 231 could be housed elsewhere (e.g., outside the formation control module 212) and communicatively coupled to the formation control module 212.

In some examples, the sensors 214 include radar, lidar, optical, or other sensors suitable to sense properties of the formation such as the relative positions, accelerations, velocities, and attitudes of the satellites and the object being imaged.

The formation control module 212 receives sensor data from the sensors 214 as input and processes that input in the state estimator module 222 to determine a relative state 224 of the formation. In general, the relative state 224 of the formation is a function of various parameters of the second satellite 102B and the first satellite 102A, quantified by the sensor data from the sensors 214. The sensor data can include data related to a position, velocity, trajectory, attitude, altitude, orientation of the satellites 102A or 102B, relative to each other, an observer on Earth, or the object 104. The sensor data can include information related to the communication link 103, such as a latency, bandwidth, or ping between the satellites 102A and 102B, the object 104, or an observer on Earth. In some cases, the image data 216 may inform a determination of the relative state 224 (shown in dashed lines due to the use of image data being optional). For example, the image data 216 can include resolution, angle, clarity, pixel count, among others, that relate to the relative positions of the satellites and the object.

In some examples, the state estimator module 222 implements a navigation filter, such as a Kalman filter or an extended Kalman filter, to fuse measurements from multiple sensors and produce a statistically optimal estimate of the relative state 224. The navigation filter propagates the state forward in time using a dynamic model of the relative orbital motion and updates the state estimate as new sensor measurements arrive. In some examples, the state estimator module 222 also estimates and compensates for sensor biases and noise characteristics. In cases where the image data 216 is used as an input, the navigation filter can incorporate image-derived measurements, such as the observed offset of the target projection on the detector, as additional measurement updates that refine the relative position estimate.

The relative state 224 of the formation and imaging parameters 226 of the X-ray emitter and sensor are provided as input to the guidance module 228, which processes the input to generate guidance commands 229 (e.g., desired change in velocity and desired pointing). In some examples, the imaging parameters 226 include parameters such as transmission power (e.g., where high transmission power typically results in the formation being less sensitive to relative perturbations in the formation), types of X-ray (e.g., soft or hard), angular resolution, effective area, time resolution, spectral resolution, etc. The guidance module is described in greater detail below.

The guidance module 228 provides the guidance commands 229 as input to the controller 231, which uses the guidance commands 229 to issue effector commands to the effectors 233 of the second satellite 102B, causing the effectors to actuate (e.g., to hold position relative to the RSO during image acquisition). The guidance commands 229 may also be transmitted to the first satellite 102A over the transmission link 103, causing the effectors of the first satellite to actuate.

In some examples, the controller 231 implements a phase plane control law that translates the guidance commands 229 into discrete thruster firing commands. The phase plane controller monitors the relative position and velocity errors between the current state and the commanded state and triggers thruster firings when the trajectory in position-velocity phase space crosses a predefined boundary. The size of the phase plane boundary determines the tradeoff between position control accuracy and propellant consumption: a tighter boundary produces more accurate station-keeping at the cost of more frequent thruster firings, while a looser boundary conserves propellant at the cost of larger position deviations. In some examples, the phase plane boundaries are selected based on the image quality requirements, such that the maximum allowable position deviation corresponds to a target projection offset that remains within acceptable imaging bounds. In some examples, smaller thrusters are used to achieve finer velocity increments per firing, which reduces propellant consumption for a given level of position control accuracy.

### 2.1 Guidance Module

There are multiple ways that the guidance module can ensure successful imaging of an RSO. One way is to ensure proper alignment of the formation and another way is to adjust the formation based on image quality. These techniques can be used separately or in combination (e.g., formation alignment and relative positioning data can be used as an input to the image quality based control).

### 2.1.1 Formation Alignment Control

In general, successful imaging of an RSO requires that (1) the projection of the RSO in the X-ray cone is completely on the detector and (2) the position of the RSO projection on the detector is known to a sufficient accuracy such that the image can be integrated over the exposure period without significant blurring (e.g., that the position is known within the detector resolution).

### 2.1.1.1 Projection of RSO on Detector

In some examples, ensuring that the projection of the RSO in the X-ray cone is completely on the detector is addressed using emitter and detector satellite guidance, navigation and control. For example, at 10 km range, a typical relative sensing suite includes a ranging sensor (e.g., laser, RF) and a bearing sensor (e.g., optical camera). Relative position estimates resulting from that sensor suite and navigation filters may be relatively large, around 20-50 meters per axis. It is likely more effective, therefore, to use bearing measurements instead of position estimates to keep the X-ray cone aligned with the target. The detector vehicle can use shared information between the satellites (sometimes referred to as “chaser satellites”) to maintain pointing to the emitter. Then, relative position changes shift and slightly skew the projection of the target onto the detector, but the line between the detector and emitter is held with high accuracy.

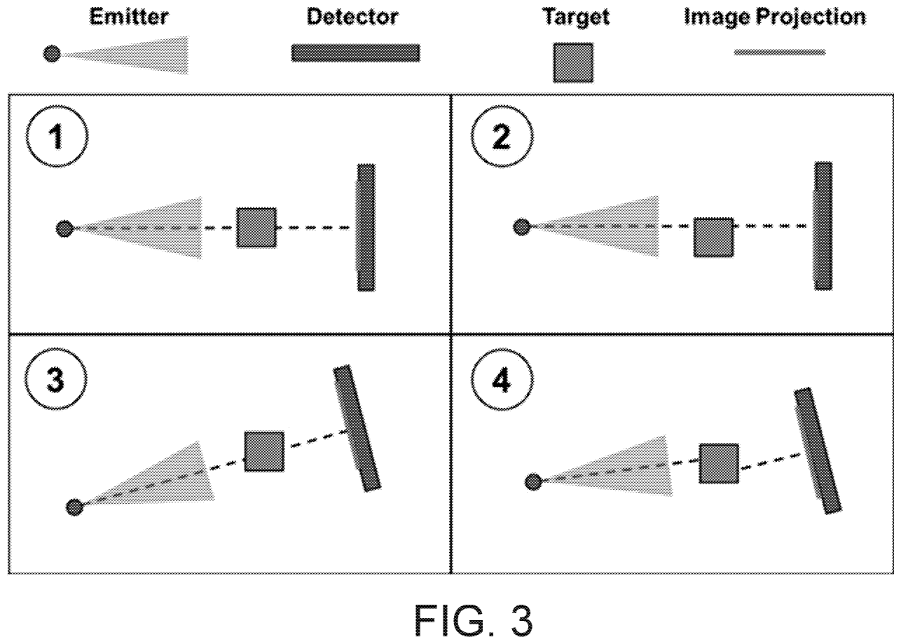

For example, referring to FIG. 3, in a first configuration (1), the emitter and detector are perfectly aligned with the center of the target. The image is projected without skewing into the center of the detector. In a second configuration (2), the emitter and detector are perfectly aligned with each other but offset laterally on the target. The image is projected without skewing and is offset from the center of the detector. In a third configuration (3), the emitter and detector are perfectly aligned with each other but pointed at an angle relative to the desired imaging face of the target. The image is skewed and projected into the center of the detector. In a fourth configuration, the emitter and detector each have position and pointing errors relative to the target. The image is skewed and offset from the center of the detector.

Pointing accuracy of the imaging spacecraft relative to the target is a function of two major factors: pointing control accuracy and relative bearing knowledge.

Pointing Control Accuracy-When not maneuvering, spacecraft attitude control can be accomplished with high accuracy using, for example, reaction wheels. However, the pointing problem becomes more challenging when the vehicle is maneuvering in order to hold position while imaging a target. The bandwidth of the controller and actuators should be large enough to reorient the spacecraft while thrusting, during which time the line-of-sight to the target is changing. For tight pointing requirements, this may drive the use of small thrusters for fine attitude control. In order to maintain pointing, these thrusters need to be used frequently, expending more propellant.

Relative Bearing Knowledge-Relative bearing knowledge depends on the sensor(s) available to measure bearing to the target. A typical bearing sensor uses optical or infrared imagery, and accuracy depends on the field-of-view (FOV), resolution, and range to target. For a very tight accuracy requirement (e.g., 1 mrad) it may be necessary to have several sensors, for example one wide-FOV sensor for coarse target acquisition and one narrow-FOV sensor to produce an accurate bearing estimate. In addition to the image itself, the sensor should also be equipped with a centroiding algorithm to estimate the bearing to the centroid of the target. Depending on the sensor, this may be included in the package or may be required as a separate module that processes image data. An additional consideration for optical sensors is Sun (or other body) exclusion angles. The imager should point away from the Sun and distinguish between the target and background objects, including the cooperating satellites.

Ultimately, the ability of a spacecraft to accurately point at a target is subject to the root-mean-square (RMS) sum of errors due to pointing control and relative bearing knowledge. Actuator selection, sensor selection, control algorithms, and navigation algorithms are all selected with the pointing requirement in mind.

### 2.1.1.2 Position of Projection on Detector

In some examples, ensuring that the position of the RSO projection on the detector is known with sufficient accuracy is addressed in part on orbit and in part on the ground when post-processing the image. The relative state estimates of each chaser provides some information. Additionally, imagery from a camera from each vehicle coupled with easily identifiable features (e.g., fiducials) on the detector may be used to estimate where the projection of the RSO falls on the detector with high accuracy.

In order to keep the projection on the detector, relative position station-keeping errors induced by guidance and control should be at least smaller than the margin between the edge of the detector and the edge of the target projection when all three vehicles are perfectly aligned. Practically, accuracy may need to be even better to account for skewing/enlargement of the projection due to changes in range and pointing misalignment.

To build a clear image, knowledge of the location of the projection onto the detector should be at least as good as the resolution of the detector. The chaser navigation performance should be sufficient to enable high-accuracy estimation of the relative positions and bearings between the three vehicles. Additionally, control performance should be sufficient to always maintain the projection of the target on the detector.

### 2.1.2 Image Quality-Based Formation Control

In some examples, the guidance module 228 builds upon a conventional relative positioning and orientation algorithm (e.g., the commercial resupply services relative positioning and orientation algorithm) but modifies the conventional optimization algorithm's cost function to maximize image quality while incorporating a cost or penalty on propellant consumption to ensure efficient maneuvering. For example, the cost function may incorporate a weighted trade-off between imaging quality and propellant expenditure. In one example, the optimization process is structured as a multi-objective optimization problem, where the primary objective is to optimize the geometry of the imaging system by adjusting satellite positions and orientations to maximize image quality in the received X-ray image data 216. In some examples, the optimization algorithm is constrained by the orbital dynamics of the satellites, sensor parameters (e.g., field of view), and available propellant.

In one example, the cost function/takes the form of a weighted sum:

$$J = {w}_{1} \cdot {C}_{image} + {w}_{2} \cdot {C}_{fuel}$$

where C_{image} represents the degradation in image quality relative to an optimal formation geometry, C_{fuel} represents the propellant expenditure required to adjust the formation, and w₁ and w₂ are weights that reflect the relative importance of the two objectives. A higher w₁ causes the algorithm to prioritize image quality, while a higher w₂ causes the algorithm to prioritize propellant conservation. In some examples, the weights are fixed for a given mission. In other examples, the weights are adjusted dynamically based on current conditions, such as remaining propellant budget or proximity to a critical imaging window.

The image quality term C_{image} can incorporate one or more factors such as the offset of the target projection from the center of the detector, the fraction of the target shadow that falls within the detector boundaries, the estimated blur due to target motion across the detector during the integration period, and the signal-to-noise ratio of the received X-ray signal. The fuel term C_{fuel} can be expressed as a function of the total Delta-V required across all vehicles in the formation to reach a desired configuration, for example as the sum of squared velocity changes across all thrusters.

In some examples, the algorithm applies a threshold-based decision structure. When C_{image} remains below a predetermined threshold, no corrective maneuver is commanded and the formation is allowed to drift within acceptable bounds. When C_{image} exceeds the threshold, the algorithm solves the optimization problem to determine the minimum-fuel correction that restores image quality. This approach avoids continuous low-level maneuvering and concentrates propellant use on corrections that produce meaningful improvements in image quality.

In some examples, a hard constraint on minimum propellant reserve is imposed on the optimization so no corrective maneuver is commanded if doing so would reduce the remaining propellant below a predetermined reserve level. In other examples, the weights w₁ and w₂ are adjusted as a function of remaining propellant, increasing w₂ as propellant decreases so that the algorithm progressively favors conservation over image quality as the mission budget is consumed.

In some examples, the guidance module 228 incorporates all the features described above for successful imaging, while in other examples, the guidance module 228 may incorporate some of the techniques described above, while omitting others.

### 3 X-Ray Imaging System

The X-ray imaging system implemented by the satellites, as described above, is configured to provide high resolution and low-noise images.

### 3.1 System Geometry and Imaging Resolution

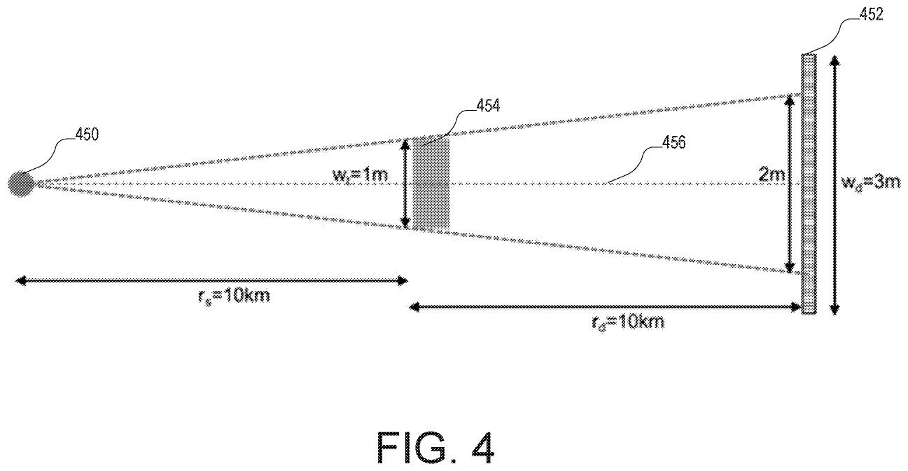

Referring to FIG. 4, an exemplary configuration of the satellite formation has an X-ray source 450 projecting an X-ray beam toward an X-ray detector 452. In the exemplary configuration, the X-ray beam is approximately 40 m wide when it reaches the detector 452, positioned 20 km away. To achieve that beam width, the pointing accuracy of the X-ray source is better than

$$\pm \frac{20 m}{20 km} = 1 mrad = 0.057 deg .$$

The target 454 casts a shadow on the X-ray detector. The size of target shadow on the detector is the actual width of the target times a magnification factor

$$γ = \frac{{r}_{s} + {r}_{d}}{{r}_{s}}$$

which is equal to 2 for the exemplary configuration of FIG. 4. In general, the goal is to have the entire X-ray shadow of the target fall completely on the detector for the full integration time of the observation. The general formula for the alignment requirement is

$$δ x < \frac{{w}_{d}}{2 γ} - \frac{{w}_{t}}{2}$$

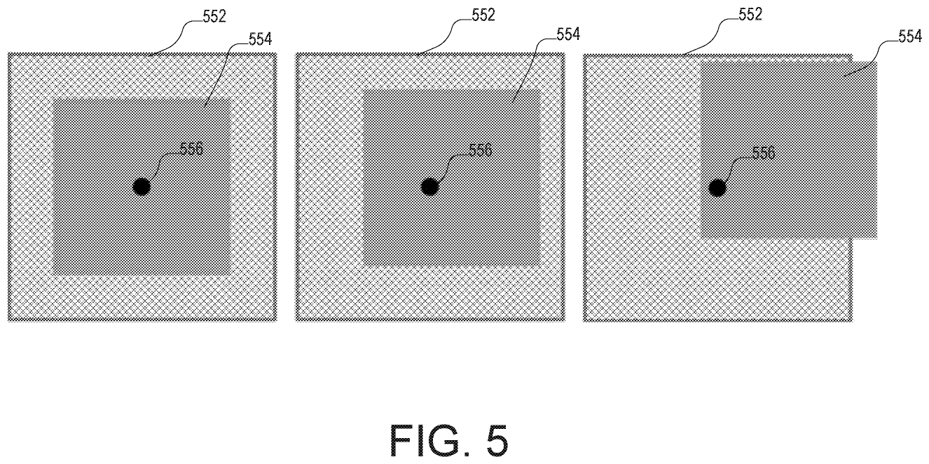

For an example case where the source 450 and detector 452 are the same distance from the target (γ=2), the target is 1 m wide, and the detector is 3 m wide the target should be within 25 cm of the centerline 456 for the full imaging time in order to be completely imaged. It may be acceptable to have parts of the target drift outside the imaging region if that section is imaged separately or if it is acceptable to lose some X-ray statistics for that region. For example, in FIG. 5, a 1-meter target 554 in front of a 3-meter detector 552 is shown as seen from the source along a centerline 556. In the first case the target is perfectly centered on the detector. In the second case it has drifted enough that it smears the image. In the third case the shadow of the target is partially off the detector and a portion of the target is not being imaged.

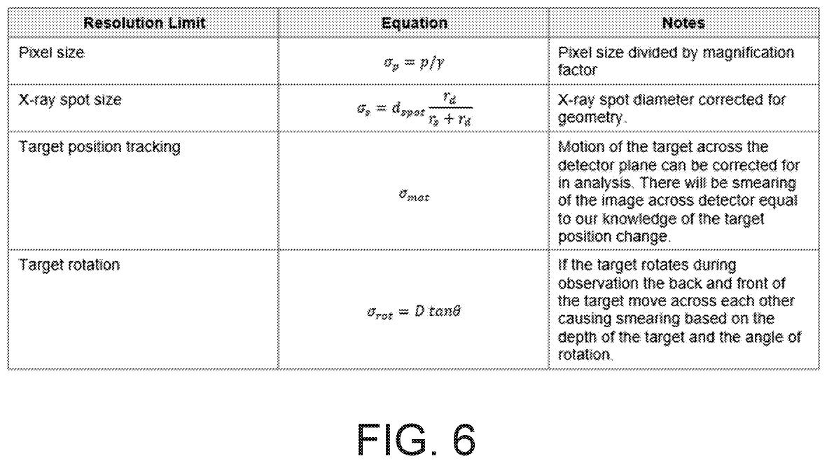

The imaging resolution is determined by a number of factors including detector pixel width (p), X-ray spot size (dₛₚₒₜ), how precisely the target position change perpendicular to the beam (σₘₒₜ) is known, and how much the target rotates during imaging (Grot). Note that the X-ray spot size (i.e., the physical size of the X-ray beam where it hits the target) from the source is on the order of ~1 mm, but the use of polycapillary optics could increase the diameter to 1-3 cm. Referring to FIG. 6, a summary of the imaging resolution factors is provided.

The total resolution of the system is a combination of all of these factors which can be estimated as

$${σ}_{tot} = \sqrt{{σ}_{{p}^{2}} + {σ}_{s}^{2} + {σ}_{{mot}^{2}} + {σ}_{{rot}^{2}}}$$

As an example, if an imaging resolution of 4 cm is required with all the individual resolution effects equal to 2 cm and assuming that the distance from the target to the detector and the source are equal, then pixels<4 cm wide and a spot size of <4 cm (note that this is the size after the optics) are required. The position change of the target across the sensor would need to be tracked to <2 cm. And for a 1 m thick target, the target would need to rotate<1.1 degrees during imaging.

### 3.2 X-Ray Signal Characteristics

In one example, the X-ray emitter emits 150 keV at 1 kW with a spot size of 0.5 mm. The X-ray spectrum can be approximated as monoenergetic 80 keV with 0.01 X-ray photons generated for every electron in the beam. In that case, the X-ray flux outside of the detector would be

$$4800 \frac{photons}{{cm}^{2} - s} .$$

The X-ray detector has 1 cm of aluminum shielding in front of the detector to reduce background radiation. The attenuation coefficient of 80 keV photons in aluminum is μ_{Al}=0.54 cm⁻¹ so the flux after the shielding would

$$2800 \frac{photons}{{cm}^{2} - s} .$$

On a 2 cm square pixel with 100 s integration time this would give N₀=1.1×10⁶ photons. In order to image a thick target, there should be approximately 1 photon per pixel integrated over the imaging time. The maximum penetration depth of the system would be:

$$\frac{ln ( {N}_{0} )}{{μ}_{Al}} = 25.8 cm ,$$

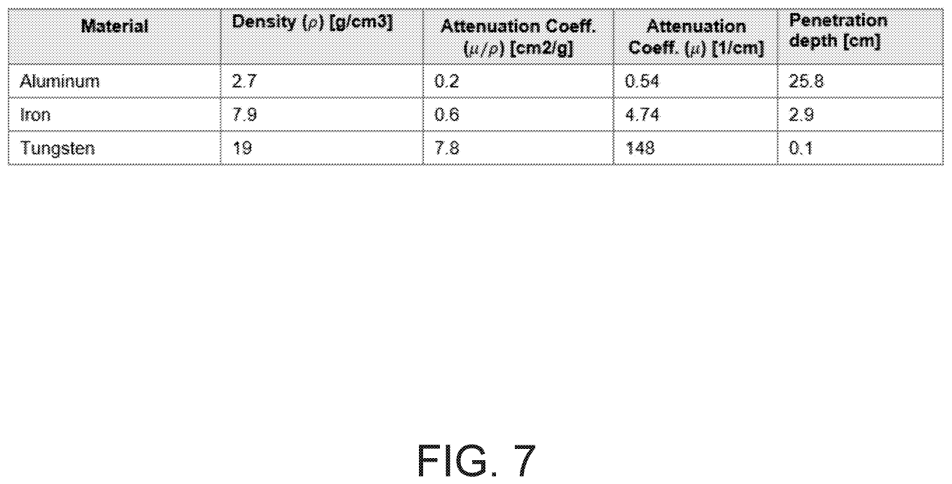

assuming that the system is limited by X-ray statistics with no background noise. Referring to FIG. 7, the penetration depth falls off quickly with higher density and higher atomic number materials.

### 3.3 Background Radiation Analysis

The background radiation in orbit produces noise that limits the penetration depth to less than the optimum case mentioned above. A simplified analysis of the signal-to-noise ratio based on the dose rate from the X-ray source and from background radiation provides estimates of the signal-to-noise ratio. A more complete analysis that simulates the interaction of X-rays, electrons, and protons with the detector and shielding materials are necessary for a more precise result. It may also be important to perform studies to optimize the shielding and the depth of the pixel detectors.

The dose rate from the X-ray source to the detector behind 1 cm of aluminum with the assumptions above is less than 1 mRad/hr (e.g., 0.73 mRad/hr). For comparison, the dose rate behind 1 cm of aluminum shielding at 400 km altitude (ISS orbit) is 20 mRad/hr. The energy delivered to the detector is 30× higher from background radiation than from the X-ray signal. In geostationary orbit (GEO) the dose rate is approximately 100 mRad/hr, 140× higher than the X-ray signal. The background in the radiation belts is approximately 2 orders of magnitude higher than this, but few satellites orbit at those altitudes due to the radiation dose. Dose rates over the pole are higher, which may make it important to choose a time to image a target in polar orbit when it is near the equator.

Signal-to-noise ratios of 1/30 or worse would make imaging infeasible. So, noise reduction strategies are used. In one example, a pulsed X-ray source is used. Using a source that provides an X-ray pulse once every 10 ms and a CsI(Tl) scintillator with, for example, a 1 ms time constant allows the system to only sample during the pulse, resulting in a factor of

$$\frac{10 ms}{1 μs} = 10 , 000$$

reduction in the background and giving a S/N ratio of 333 with no intervening material for the 400 km orbit mentioned above. Assuming that imaging through material to the point where the S/N ratio is 1 is possible, a penetration depth in aluminum of

$$\frac{ln ( S / N )}{{μ}_{Al}} = 10.7 cm$$

cm can be achieved.

Background subtraction could improve this given that there is a large background sample from between the X-ray pulses. In low earth orbit (LEO) the background is dominated by protons. The number of protons above 40 MeV (capable of penetrating 1 cm aluminum) incident on a 2 cm pixel in 100 s is approximately 300. But on average only 1/33 of a count would occur during the X-ray pulse but it would produce a very large pulse compared to the X-ray pulse detected behind a thick target so it might be easily removed, restoring the penetration depth to a value close to the maximum estimated with no background.

In GEO the background is dominated by electrons. The number of electrons above 4 MeV (capable of penetrating 1 cm aluminum) incident on a 2 cm pixel in 100 s is approximately 2E5. Only about 20 of those would arrive during the X-ray pulses. The statistical noise on the background would be √20=4.5. This would reduce the noise by a factor of 4.5 and give a penetration depth in aluminum of

$$\frac{ln ( S / N )}{{μ}_{Al}} = 10.7 cm ,$$

similar to what would be achieved in LEO without background subtraction.

### 4 Vehicle Design Considerations

In general, the imaging satellites (i.e., the “chaser vehicles”) are high Delta-V vehicles capable of performing rendezvous and proximity operations. In some examples, the distance between each chaser vehicle and the target is on the order of 10 km. The imaging satellites are capable of operating in low earth orbit, medium earth orbit (MEO), and/or geostationary orbit. In some examples, the chaser vehicles have a mass on the order of 500 kg, with size on the order of 1 m³ and the payload mass of the chaser vehicles is on the order of 25 kg.

In some examples, both chaser vehicles have both emitter and receiver capabilities. The X-rays emitted by the emitter are designed to penetrate all types of spacecraft material and distinguish between high-Z (impedance) and low-Z materials. In some examples, The X-ray emitter is 150 keV at 1 kW with a spot size of 0.5 mm. In some examples, the X-ray spectrum is approximated as monoenergetic 80 keV with 0.01 X-ray photons generated for every electron in the beam. The X-ray beam may be focused by a polycapillary optics to a 40 m×40 m square area at the position of the detector (20 km from the source) with 0.02% of the photons from the source effectively focused onto that area. In some examples, 1% of 1 kW beam converts to X-rays. In general, the ideal image exposure time is between 90-120 seconds, though other image exposure times can satisfy system requirements.

### 5 Considerations for Uncooperative Targets

In some examples, when imaging an uncooperative target, it is possible that the target is maneuvering for all or part of the imaging process. This has a few important impacts on requirements and vehicle design. First, the vehicles should be at least as maneuverable (i.e., have larger translational acceleration) as the target. Second, the vehicle's control algorithms need to be designed to reject the disturbance of the maneuvering target. Third, the imaging exposure time should be small enough that the target is not able to affect a significant change to its orbit (e.g., eccentricity growth). Finally, the relative control requirements are effectively tighter, the control performance should be good enough to track the moving target and maintain the same relative position and pointing accuracy.

In some examples, the guidance module 228 detects target maneuvering by monitoring changes in the bearing measurements from the optical or infrared sensor over time. A sustained change in bearing that is inconsistent with the predicted relative motion under natural orbital dynamics is an indicator that the target is thrusting. When maneuvering is detected, the guidance module 228 can increase the frequency of formation correction maneuvers, tighten the phase plane boundaries in the controller 231, or adjust (e.g., minimize) the weights in the cost function to prioritize tracking performance over propellant conservation. In some examples, the imaging exposure time is shortened when target maneuvering is detected, to reduce the blur contribution from target motion during the integration period.

### 6 Alternatives

The image-based formation control techniques are described above in the context of X-ray imaging. But it should be recognized that the techniques are equally applicable to other types of imaging, including but not limited to visible light imaging and thermal imaging.

In some examples, the object is another satellite or other spacecraft, which may or may not be cooperative with the formation. If the object is cooperative, then the guidance module may also provide guidance commands to the object.

In some examples, both of the satellites independently execute their own image-aware relative positioning and orientation algorithm. In other examples, only one of the satellites (e.g., the second satellite 102B) executes an image-aware relative positioning and orientation algorithm, but the other satellite(s) execute non-image-aware relative positioning and orientation algorithms (e.g., to ensure that they behave predictably for the image-aware relative positioning and orientation algorithm).

In some examples, the image-aware relative positioning and orientation algorithm is executed at a ground station (e.g., on Earth) and the required sensor data and commands are transmitted between the satellites and the ground station over a transmission link (e.g., a radio frequency transmission link).

In some examples, the image-aware relative positioning and orientation algorithm is agnostic to vehicle design, resulting in a generic solution that can be used across a wide variety of spacecraft and satellites.

Thrusters are one type of effector that can be used in the systems described above. But the formation guidance algorithm is agnostic to the type of actuator that is used (e.g., the actuator could be a combination of thrusters and reaction wheels) unless the actuator types influence the cost function (e.g., propellant use).

In some examples, the formation control module 212 is implemented on the first satellite 102A rather than the second satellite 102B. In other examples, the formation control module 212 is distributed across both satellites, with different components of the module executing on different vehicles and communicating over the communication link 103.

### 7 Formation Flight Quality Assessment Tool

Not all spacecraft and satellites are capable of the formation flight required for imaging missions like the one described above. Small errors and uncertainties, such as sensor errors and space weather, may affect the performance of a formation flight mission. Some aspects described herein relate to an assessment tool to generate expected image quality metrics based on the performance of a formation flight mission.

In some examples, the assessment tool uses a model of the imaging system mounted to the satellites to estimate what the resulting image will look like given a particular formation flight configuration. Based on the imager parameters and the relative state between the satellites and the target, the tool estimates image quality metrics such as the resolution of the target in the image, the clarity of the image, and the fraction of the target that falls within the detector field of view. Additionally, the tool uses expected relative state uncertainties, atmospheric uncertainties, and uncertainty in the imager parameters themselves to estimate the uncertainty in those image quality metrics. This information can be used to draw conclusions about worst-case image quality given performance characteristics and expected uncertainties throughout a particular mission.

In some examples, the assessment tool operates in a forward direction: given a description of the formation flight performance (e.g., position control accuracy, velocity control accuracy, navigation error statistics), the tool computes the resulting image quality metrics and their uncertainties. In other examples, the assessment tool operates in an inverse direction: given a set of desired image quality metrics, the tool derives the formation flight performance requirements, such as position deadband, navigation accuracy, and thruster sizing, needed to achieve those metrics. This inverse capability can be used during mission design to establish vehicle requirements from top-level imaging objectives, without requiring iterative manual analysis.

In one use case, the assessment tool is used to determine vehicle suitability. A candidate vehicle with known navigation and control performance is evaluated against the imaging requirements, and the tool determines whether the resulting image quality is acceptable. Unsuitable vehicles will have formation flight performance that results in poor image quality.

In another use case, the assessment tool is used to generate formation flight requirements from desired image quality metrics. For example, a requirement for a particular imaging resolution can be translated into a maximum allowable target motion across the detector during the integration period, which in turn can be translated into a position control accuracy requirement for the chaser vehicles.

### 8 Implementations

The approaches and methods described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more associated modules of a larger program, for example, that provides services related to the design, configuration, and execution of data processing graphs. The modules of the program (e.g., elements of a data processing graph) can be implemented as data structures or other organized data conforming to a data model stored in a data repository.

In some examples, the formation control algorithm is executed onboard one or more of the space vehicles using a radiation-hardened processor suitable for the space environment. In such examples, the computational complexity of the optimization may be constrained by the available processing resources, and the algorithm may be implemented using a simplified or approximate optimization technique that is compatible with real-time execution within the available computational budget.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for controlling a formation of space vehicles to image an object, the method comprising:
receiving image data acquired by one or more of the space vehicles in the formation;
forming state estimate data for the formation of space vehicles, the state estimate data being based at least in part on relative positions and orientations of the space vehicles in the formation; and
determining one or more guidance commands for the space vehicles in the formation based at least in part on the state estimate data, the one or more guidance commands being determined to orient the space vehicles relative to the object for imaging of the object.

2. The method of claim 1 wherein the one or more guidance commands are determined to maximize an image quality of the image data while satisfying one or more vehicle constraints associated with the space vehicles.

3. The method of claim 1 further comprising receiving one or more imaging parameters associated with the formation of space vehicles, wherein determining the one or more guidance commands for the space vehicles in the formation is further based on the one or more imaging parameters.

4. The method of claim 3 wherein the image data is X-ray image data.

5. The method of claim 4 wherein a first space vehicle in the formation transmits X-ray radiation and a second space vehicle in the formation receives at least some of the transmitted X-ray radiation.

6. The method of claim 5 wherein the one or more imaging parameters includes a power of the transmitted X-ray radiation.

7. The method of claim 5 wherein the object being imaged is located between the first space vehicle and the second space vehicle.

8. The method of claim 7 wherein the object is a satellite.

9. The method of claim 7 wherein the object is part of the formation.

10. The method of claim 7 wherein the state estimate data is further based at least in part on the relative position and orientation of the object.

11. The method of claim 1 wherein the image data is visible light image data.

12. The method of claim 1 wherein the one or more guidance commands include one or more of a desired change in velocity command and a desired pointing command.

13. The method of claim 1 wherein determining the one or more guidance commands includes using an optimization technique.

14. The method of claim 1 wherein the state estimate data is further based at least in part on a quality of the image data.

15. The method of claim 1, wherein determining the one or more guidance commands includes:
computing an image quality cost based at least in part on the image data; comparing the image quality cost to a threshold; and
determining a corrective guidance command only when the image quality cost exceeds the threshold.

16. The method of claim 1, wherein determining the one or more guidance commands includes minimizing a cost function that comprises a weighted sum of an image quality term representing a degradation in image quality of the image data and a propellant expenditure term representing a propellant cost of adjusting the formation, wherein the weighted sum is based on a first weight applied to the image quality term and a second weight applied to the propellant expenditure term.

17. A system for controlling a formation of space vehicles to image an object, the system comprising:
an input for receiving image data acquired by one or more of the space vehicles in the formation;
a state estimation module for forming state estimate data for the formation of space vehicles, the state estimate data being based at least in part on relative positions and orientations of the space vehicles in the formation; and
a guidance module for determining one or more guidance commands for the space vehicles in the formation based at least in part on the state estimate data, the one or more guidance commands being determined to orient the space vehicles relative to the object for imaging of the object.

18. The system of claim 17 wherein the one or more guidance commands are determined to maximize an image quality of the image data while satisfying one or more vehicle constraints associated with the space vehicles.

19. Software stored on a non-transitory computer-readable medium, the software comprising instructions for causing a computing system to control a formation of space vehicles to image an object, the instructions causing the computing system to:
receive image data acquired by one or more of the space vehicles in the formation;
form state estimate data for the formation of space vehicles, the state estimate data being based at least in part on relative positions and orientations of the space vehicles in the formation; and
determine one or more guidance commands for the space vehicles in the formation based at least in part on the state estimate data, the one or more guidance commands being determined to orient the space vehicles relative to the object for imaging of the object.

20. The software of claim wherein the one or more guidance commands are determined to maximize an image quality of the image data while satisfying one or more vehicle constraints associated with the space vehicles.
